(19) United States
(12) Patent Application Publication
(10) Pub. No.: US 2004/0139985 A1
(43) Pub. Date: Jul. 22, 2004

(54) Rate monitor for wet wafer cleaning

(75) Inventors: Andreas G. Hegedus, Burlingame, CA (US); Steven Verhaverbeke, San Francisco, CA (US)

Correspondence Address: PATENT COUNSEL, APPLIED MATERIALS, INC., Legal Affairs Department, P.O.BOX 450A, Santa Clara, CA, 95052, US

(73) Assignee: Applied Materials, Inc.

(21) Appl. No.: 10/349,591

(22) Filed: Jan. 22, 2003

(51) Int. Cl. B08B 3/02

(52) U.S. Cl. 134/1.3; 134/18; 134/34; 134/56 R; 134/94.1; 134/113; 134/148; 134/184

(57) ABSTRACT

A rate monitor connected to a single-wafer cleaning device to measure and control a wet cleaning process. During the wafer cleaning process the rate monitor can monitor a rate at which changes are being made to a portion of the wafer, as the wafer is covered with a liquid, and predict an endpoint in time to the wet cleaning process.

### FIELD

The present invention relates generally to the field of semiconductor fabrication and, more specifically, to wafer cleaning.

### BACKGROUND

In semiconductor substrate (wafer) cleaning, wet cleaning is essential. Wet cleaning may include both chemical and mechanical means for wet etching thin film layers and/or removing particles on a wafer surface. In the current state of art, one means of wet cleaning includes the use of an acoustic energy cleaning device. An acoustic energy cleaning device utilizes a process wherein a wafer is placed in a liquid bath and high frequency irradiation, or cavitation, is applied to the liquid in the bath. At the same time, chemicals in the liquid provide a surface etching to layers on the wafer. The surface etching and cavitation together provide mechanical and chemical actions that clean the wafer surface.

Typically, a wafer is cleansed in a batch process. A batch process involves placing a group of wafers in the liquid bath and cleaning the group of wafers simultaneously. The timing of the cleaning etch in the bath may occur in phases and is estimated based on the strength of the chemicals in the liquid and the energy of the cavitation. For example, a first phase may include a first timed etch after which the wafer is removed from the liquid bath and the thickness of the layers on the wafer are measured. If the measurement indicates that the wafer has not been sufficiently wet etched, the wafer is placed back into the liquid bath for a second timed etch. This process of performing a timed wet etch, removing the wafer from the liquid bath, measuring the wafer thickness, replacing the wafer in the liquid bath, and performing another timed etch may repeat until the layer surfaces on the wafer are adequately etched and cleansed.

The batch process, however, suffers from various problems. For example, the batch process is timely. The various steps of etching the wafer, removing the wafer from the liquid bath, measuring the wafer, and repeating the etch take valuable time. The batch process is clumsy and inefficient. The wafer has to be moved around leading to potential risks of damaging delicate portions of the wafer. The batch process is imprecise. The timing of each cleaning etch can only be estimated and cleaning etch results can only be verified by removing the wafer from the bath to make measurements.

Some typical batch process utilize chemical etch stop monitors that measure chemistry changes to the liquid bath and estimate the cleaning etch rate accordingly. However, chemistry readings in the liquid are not entirely accurate and therefore chemical etch stop monitors are imprecise, sometimes leading to excessive etching of layers on the wafer.

### SUMMARY

A rate monitor for wet wafer cleaning is described. The rate monitor is connected to a single-wafer cleaning device to measure and control a wet cleaning process. During the wafer cleaning process the rate monitor can monitor a rate at which changes are being made to a portion of the wafer, as the wafer is covered with a liquid, and predict an endpoint in time to the wet cleaning process. Knowledge of the endpoint may be utilized to optimize and control various aspects of the cleaning process.

Other features, according to other embodiments of the present invention, will be apparent from the accompanying drawings and from the detailed description that follows.

### BRIEF DESCRIPTION OF THE DRAWINGS

Embodiments of the present invention are illustrated by way of example and should not be limited by the figures of the accompanying drawings in which like references indicate similar elements and in which:

FIG. 1 illustrates a wet cleaning system according to one embodiment of the invention;

FIGS. 2A-2B illustrate a rate monitor according to one embodiment of the invention;

FIG. 3 illustrates a rate monitor according to one embodiment of the invention;

FIG. 4 illustrates a side view of one embodiment of a single-wafer cleaning device and an in situ ellipsometer;

FIGS. 5A-5F illustrate a method of monitoring and controlling a wet etch within a cleaning process according to one embodiment of the invention; and

FIG. 6 is a representation of a computer system that may be utilized in conjunction with embodiments of the invention described herein.

### DETAILED DESCRIPTION

Described herein is a rate monitor for wet wafer cleaning. In the following description numerous specific details are set forth. One of ordinary skill in the art, however, will appreciate that these specific details are not necessary to practice embodiments of the invention. While certain exemplary embodiments of the invention are described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

Briefly, the rate monitor is utilized to monitor the rate at which changes are occurring to a portion of the wafer, such as to a thin film that overlies the wafer, during a single-wafer cleaning process. Based on the rate that the changes are occurring, the rate monitor can predict an endpoint reference in time. The endpoint may correspond to a point in time when one phase of the wet cleaning process will end and another will begin. Once the endpoint in predicted, the wet cleaning process can be controlled before the actual endpoint occurs, so that events that normally would have been performed after the endpoint had occurred, may now be performed previous to the predicted endpoint. In other words, the rate monitor can determine how quickly the end of a wet cleaning process is approaching, determine what needs to be done before the endpoint is reached, and do those things that need to be done. The next phase of the cleaning process, therefore, may occur without unnecessary switching delays and the cleaning process is thus expedited. Exemplary cleaning processes in a single-wafer cleaning device include thin film removal (e.g., oxide, nitride, photoresist), particle removal, selective thin film removal, etc. Hence, the rate monitor may observe one of various characteristics of the wafer such as thin film thicknesses, chemical changes to the solution, etc.

According to one embodiment of the invention, the rate monitor may be utilized within a single-wafer cleaning device to remove thin films on the wafer. In semiconductor processing, cleaning techniques must be utilized at various times throughout the semiconductor process to remove thin films from the wafer. For example, during the formation of a transistor on a wafer, a gate oxide layer may need to be grown directly onto the top of the wafer as part of a process to form a transistor. However, before the gate oxide can be grown, isolation regions may need to be formed within the wafer, which may require the deposition of various thin film layers directly onto the wafer surface, such as a pad oxide layer and a nitride mask layer. Once the isolation regions are formed, the pad oxide layer and nitride mask layer would need to be removed so that the gate oxide can be deposited directly onto the wafer surface.

Removal of these thin film layers (e.g., oxides, nitrides, etc.) may be accomplished by wet etching. Wet etching, also known as blanket etching, exposes all surfaces on the wafer exposed to the etchant and is very useful for removing thin film layers without damaging the underlying wafer. Wet etching may also be described herein as “wet cleaning” because the wet etch is part of the cleaning process and may include other cleaning steps (e.g., rinsing, cavitation, etc.) that tend to remove any residue of the etchant or particles of the thin film layers that may be left following the wet etch. Hence, the wet cleaning processes is an essential part of semiconductor fabrication.

Thus, the wafer may be placed inside a singe-wafer cleaning device. The rate monitor may be situated in situ, or in other words, inside the wafer cleaning device. The rate monitor may include an optical measuring device, such as an ellipsometer, to make optical measurements that relate to a thickness of a thin film on the wafer. The optical measuring device can make optical measurements, or in other words measure optical path lengths of a light beam, that relate to a thickness of the thin film on the wafer as the thin film is being wet etched, cleansed, or in other ways processed by the cleaning device. Thus the optical measurements are made in real time, or as the wet process is occurring, and the optical measurements may be utilized to determine an etch rate and to predict an endpoint of the wet cleaning process based on the etch rate. The rate monitor, or other devices associated with the wafer cleaning device, may utilize the endpoint to optimize and control various aspects of the cleaning process that may occur in time before the endpoint has been reached in preparation for additional processing that may occur after the endpoint has been reached.

Apparatus

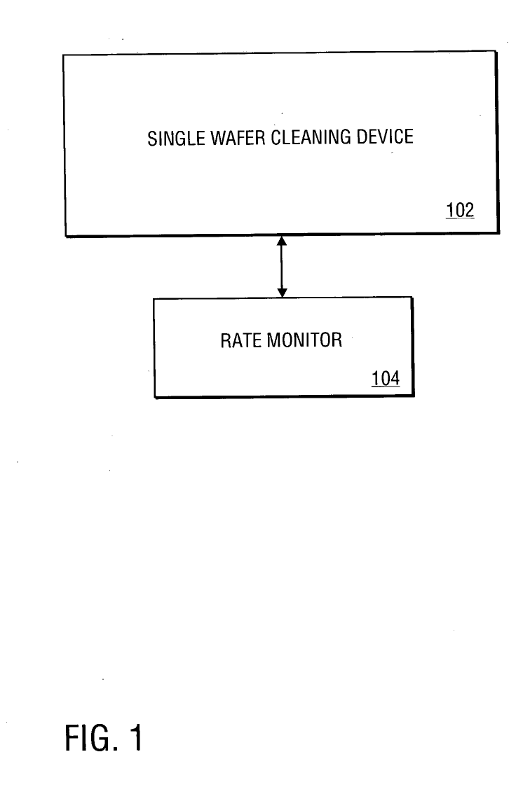

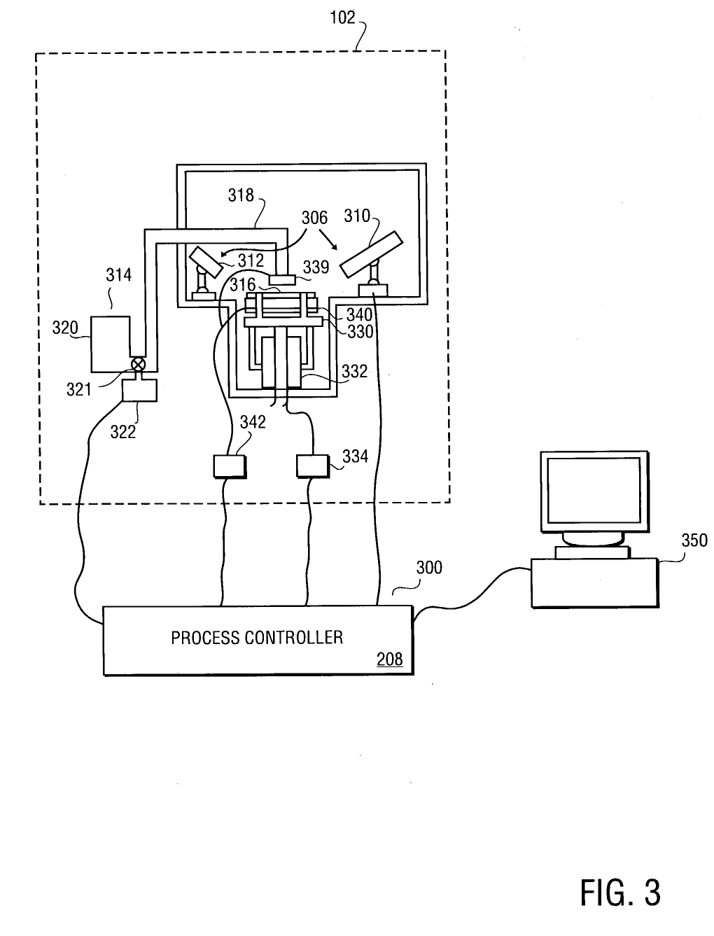

FIG. 1 illustrates a wet cleaning system according to one embodiment of the invention. Referring to FIG. 1, the wet cleaning system includes a single-wafer cleaning device 102 and a rate monitor 104 connected to the single-wafer cleaning device 102. The single-wafer cleaning device 102 is to provide a wet cleaning etch, and other cleaning processes, to a wafer. The term “wafer”, as defined herein, may encompass semiconducting materials, non-conducting materials, or combinations of semiconducting and non-conducting materials. The wafer includes a substrate comprising any one of various substrate materials known in the art, such as monocrystalline silicon. The wafer may also include structures and devices that have one or more insulative, semi-insulative, conductive, or semiconductive layers and materials. According to one embodiment of the invention, the single-wafer cleaning device 102 is a single-wafer cleaning device as described in further detail in conjunction with FIGS. 3, 4, and 5A-5F below.

The rate monitor 104 is to measure and/or control the wet cleaning process, provided by the single-wafer cleaning device 102. In one embodiment of the invention, the rate monitor 104 is to monitor changes to at least a portion of the wafer, such to a thin film that overlies a wafer, as the wet cleaning process is being performed. The changes to the wafer are monitored to predict an endpoint in time when the wafer cleaning process will terminate, or transition from one phase to another. The rate monitor 104 may be connected to one of many control devices in the single-wafer cleaning device 102 and may therefore provide control signals to the single-wafer cleaning device 102 based on any predicted endpoint. The control signals may control the power, timing, frequency, temperature, or other system variables of the single-wafer cleaning device 102. The rate monitor 102 may include hardware and/or software, or be interconnected with devices that contain hardware and/or software (e.g., a computer), to assist in controlling components of the single-wafer cleaning device 102.

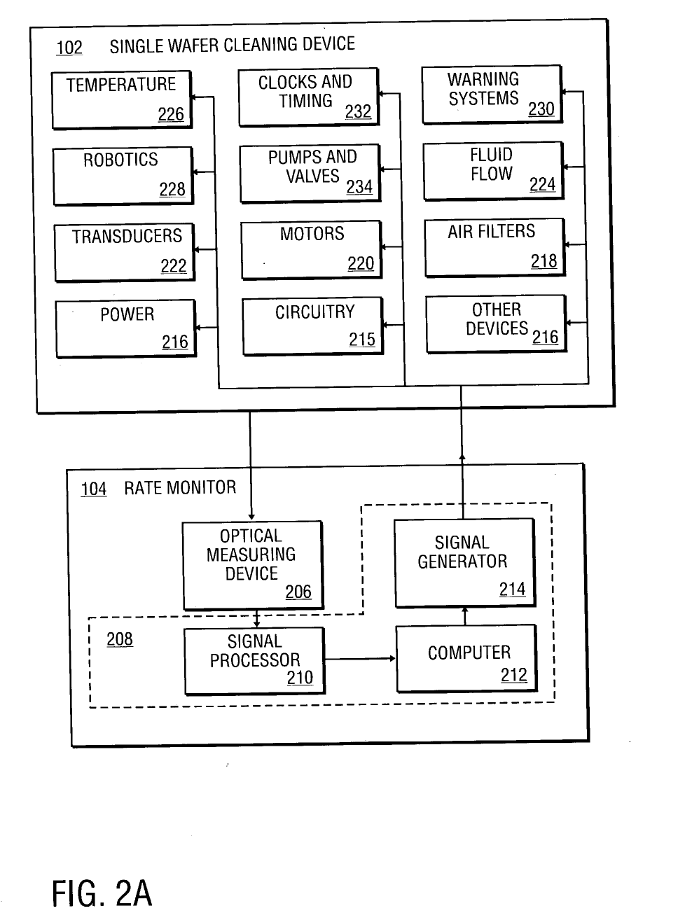

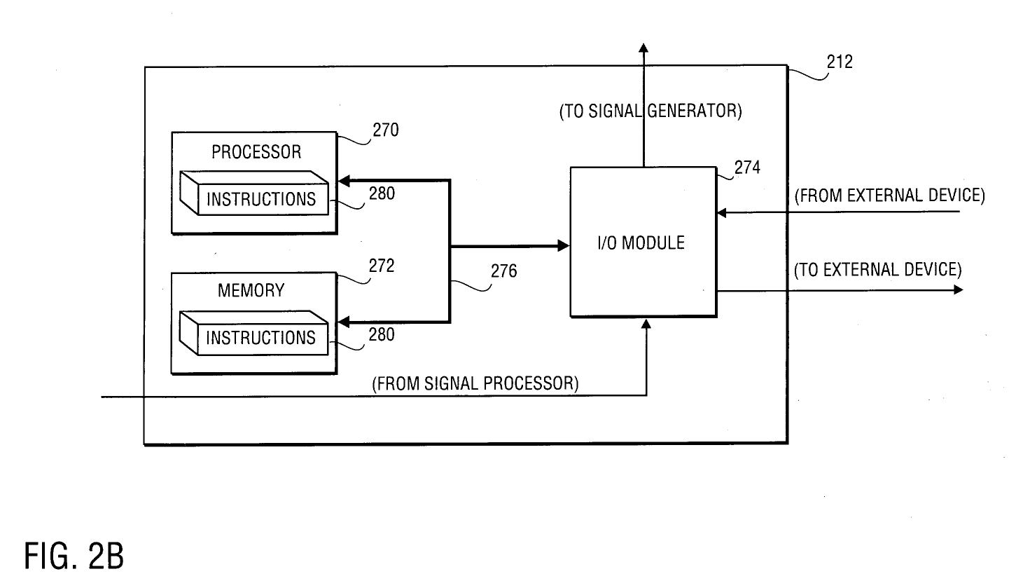

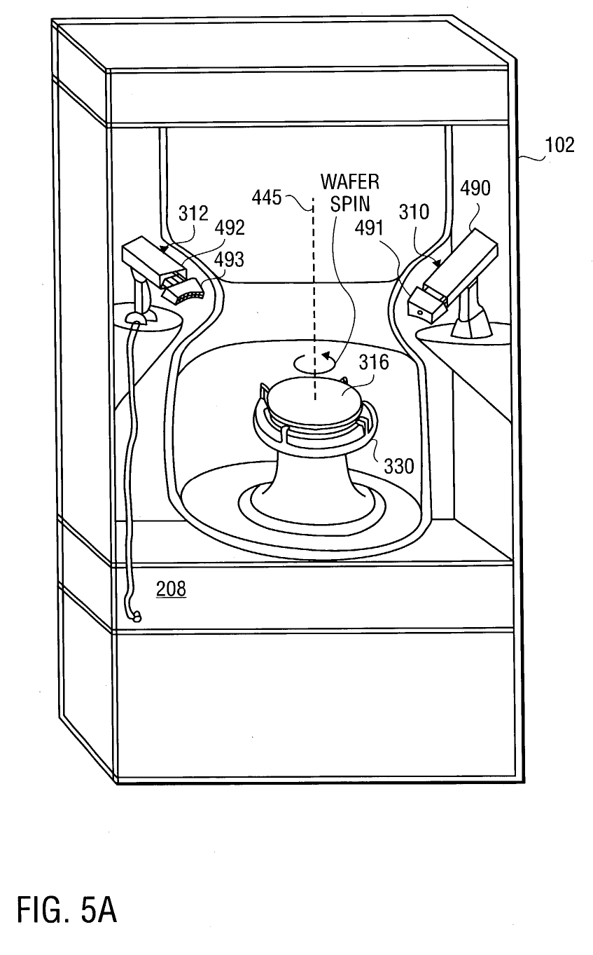

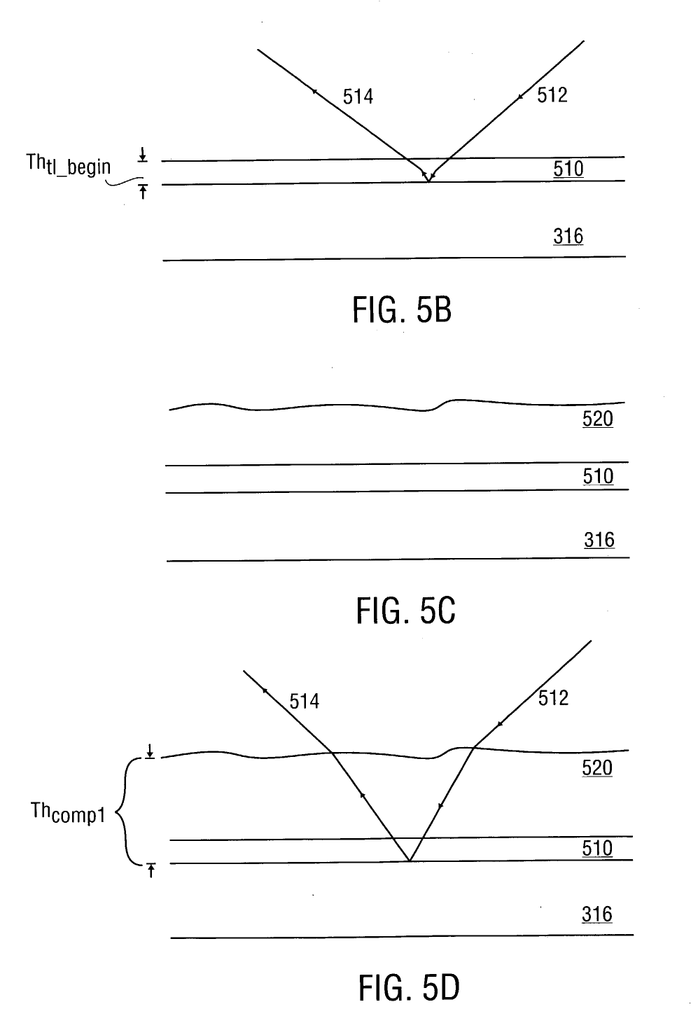

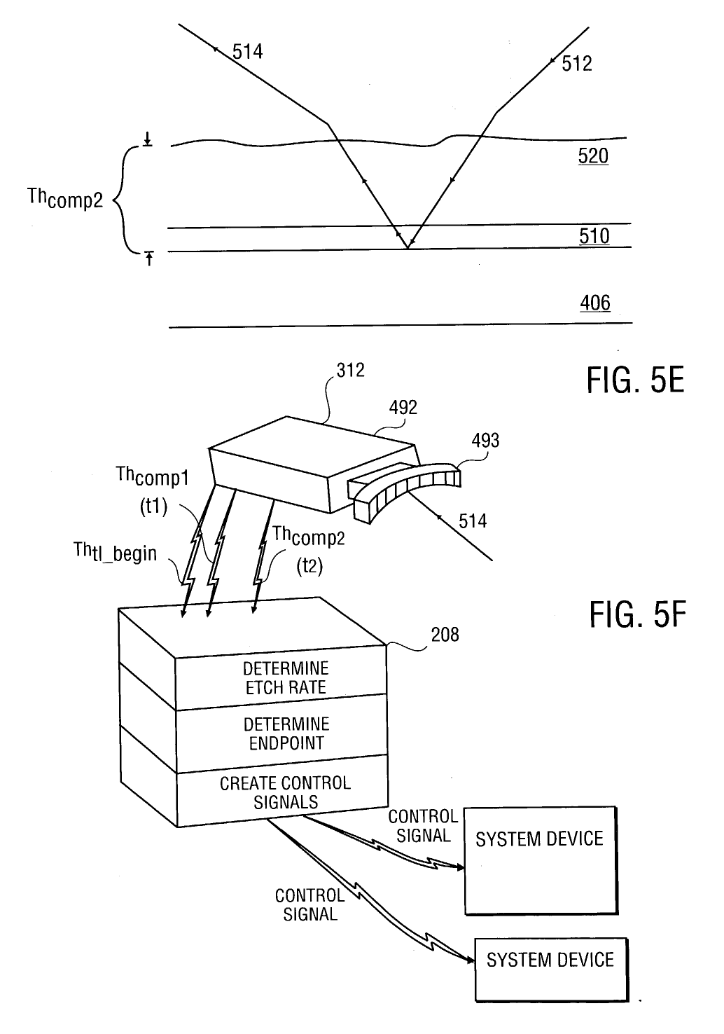

FIG. 2A illustrates one embodiment of the rate monitor 104 described in FIG. 1. Referring to FIG. 2A, the rate monitor 104 includes an optical measuring device 206 (“measurement device”) to optically monitor characteristics of the wafer, such as making optical measurements that relate to a thickness of a thin film, or other material, on a wafer inside of the single-wafer cleaning device 102. The measurement device 206 may make the optical measurement in real time, or in other words, as a wet cleaning process or etch is being performed. Therefore, the thin film, also referred to herein as the “etch layer”, may need to be measured though a liquid layer (e.g., etchant, cleaning solution, water, etc.) that covers portions of the etch layer that are to be optically measured. The liquid layer may be motionless as it overlies the wafer. However because of processing procedures performed by wafer cleaning device 102, the liquid layer may have a surface that is in motion. The optical measuring device 206 can accurately measure the thin film layer's thickness even though the liquid layer may cover the thin film layer. A method describing this process is described in more detail in conjunction with FIGS. 5A-5F below.

The rate monitor 104 may also include other devices besides the optical measuring device 206. For instance, the rate monitor 104 may also include a process controller 208 to (1) calculate an etch rate based on the optical measurements provided by the optical measuring device 206, (2) predict endpoints to the cleaning etch based on the etch rate, and (3) provide control signals to the wafer cleaning device 102 based on the predicted endpoints. The process controller 208, may be connected to the optical measuring device 206 and include individual modules, or devices. For example, in one embodiment of the invention, the process controller 208 may include a signal processor 210 to receive optical measurement signals from the optical measuring device 206 and convert the optical measurement signals into machine-readable data or “optical measurement data.” A computer 212 can then receive the optical measurement data and compute a wet cleaning etch rate (“etch rate”). The computer 212 may then utilize the optical measurement data to determine how quickly the cleaning etch is progressing (i.e., determine an etch rate), predict at least one endpoint to the cleaning etch based on the etch rate, and generate control data that can subsequently be converted into control signals by a signal generator 214.

The term “endpoint” herein represents a point in time at which a phase of the wet cleaning process would end. However, a wet cleaning etch may require many endpoints depending on how many phases of the cleaning etch process needed to be performed, and the computer 212 may predict endpoints relating to any phase of the cleaning etch process. One endpoint may be the complete end of the cleaning etch, or in other words, the point in time that a thin film layer will be completely removed. Another endpoint may represent a point in time that a thin film layer will be etched only to a pre-determined thickness. Other endpoints, however, may only represent the transition (or switch) from one fluid to another, according to the flow of the cleaning process.

The computer 212 may include various components as described in further detail in conjunction with FIG. 2B. Referring to FIG. 2B, computer 212 may include a computer processor 270, a memory 272, an input/output (I/O) module 274 to receive and transmit various signals from the computer 212, and an internal bus 276 connecting the computer processor 270, the memory 272, and the I/O module 274. The I/O module 274 may receive the optical measurement data from the signal processor 210 and transfer the data to memory 272 and/or to the computer processor 270. The computer processor 270 may process computer instructions (i.e. software) 280 stored in memory, and/or partially in both the memory 272 and the computer processor 270. The computer processor 270 may also process the optical measurement data with the software 280 to determine etch rate data (i.e. etch-rate) as described below in conjunction with FIGS. 5A-5F. Once the etch rate is determined, the computer processor 270 may utilize the etch rate with the software 280 to determine (or predict) a projected, reference point in time marking the end of the etch (i.e. the endpoint), as also described below in conjunction with FIGS. 5A-5F. Furthermore, once the endpoint has been determined, the computer processor 270 may utilize the endpoint with the software 280 to determine, or create, control signal data, which will be transmitted by the I/O module 274 to the signal generator 214. The I/O module 274 may also include inputs from, and outputs to, external devices not included in the computer 212, such as display units, audio signal generators, and keyboards or other data entry devices.

Referring back to FIG. 2A, once the computer 212 has forwarded the control data to the signal generator 214, the signal generator 214 may receive the control data and produce control signals, based on the control data, that the single wafer cleaning device 102 may utilize to control the wet cleaning process. More specifically, the signal generator 214 may provide electronic control signals that can be used by various components of the wafer cleaning device 102 such as electronic circuitry 215, power devices 216, air filter devices 218, motor devices 220, transducer devices 222, fluid flow devices 224, temperature devices 226, robotic devices 228, warning system devices 230, clocks and timing devices 232, pump and valve devices 234, and any other electronic or system control devices 236. In one embodiment of the invention, the signal generator 214 may transmit the control signals via a direct wire connection to the single-wafer cleaning device 102. In other embodiments of the invention, the signal generator 214 may provide remote radio-frequency signals, infrared signals, or other types of wireless signals, to the single-wafer cleaning device 102 and thus may be equipped with remote control transmitters. The signal generator 214 may also provide electronic control signals that can be used by various components of the rate monitor 104, such as the optical measuring device 206, the signal processor 210, the computer 212, and the signal generator 214 itself.

FIG. 3 illustrates an in situ rate monitor 300 according to one embodiment of the invention. Referring to FIG. 3, the rate monitor 300 may include an in situ ellipsometer 306 inside of one embodiment of the single-wafer cleaning device 102 connected to the process controller 208. The term “in situ” is contextually used herein to indicate that at least a portion of the described device is either contained within the single-wafer cleaning device 102 or else is in sufficient proximity to the single-wafer cleaning device 102 to measure the thickness of thin film layers on a wafer during the wet cleaning process. Thus, since the ellipsometer 306 shown if FIG. 3 is contained within the single-wafer cleaning device 102 the rate monitor 300 may be termed an “in situ” rate monitor. Other portions of the rate monitor 300 may also be contained within the single-wafer cleaning device 102, and may even be entirely contained within the single-wafer cleaning device 102, therefore merging with the single-wafer cleaning device 102. The process controller 208 may include hardware and/or software, or be interconnected with devices that contain hardware and/or software such as a computer 350.

The ellipsometer 306 includes a transmitter 310 and a receiver 312. The transmitter 310 is to transmit a polarized light beam onto a surface of a wafer 316 and the receiver 312 is to receive and analyze reflections of the light beam as the light beam reflects off of a surface on the wafer 316. According to one embodiment of the invention, the ellipsometer 306 may be phase modulating, or in other words, the ellipsometer may modulate the phase of the light beam to compensate for minor fluctuations that may result from liquids above the surface of the wafer 316. Other devices may be utilized in place of the ellipsometer as long as they can measure the thickness of thin film layers in a similar way that an ellipsometer does (i.e. through optical measuring).

Still referring to FIG. 3, the single-wafer cleaning device 102 includes at least one fluid dispenser 314 to dispense a cleaning fluid onto the wafer 316. The dispenser may include a fluid source 320 containing a pressurized fluid that may be dispensed onto the wafer 316 from above via a tube 318 positioned over the wafer 316. A valve 321 obstructs the flow of the cleaning fluid from the fluid source 320. In one embodiment of the invention, the valve 321 is electronic and a fluid flow controller 322 is connected to the valve 321 to open and close the valve 321 to produce a required fluid flow. The fluid flow controller 322 may also be connected to the process controller 208.

The single-wafer cleaning device 102 may also include at least one rotatable wafer holder 330 to hold and rotate the wafer 316 during the wet cleaning process. A motor 332 may be attached to the rotatable wafer holder 330 to rotate the wafer holder 330. A rotation controller 334 may be attached to the motor to control the motor 332 to produce variable rotation of the wafer holder 330. The rotation controller 334 may also be connected to the process controller 208.

Still referring to FIG. 3, the single-wafer cleaning device 102 may include at least one transducer assembly 339 or 340 to provide acoustic energy to a cleaning fluid during the wet cleaning etch. As shown, the transducer assembly 339 may be attached to the tube 318 so that acoustic energy is applied to any liquid that exits the tube 318 onto the wafer 316. Additionally, a transducer assembly 340 may be attached to the rotatable wafer holder 330 to transmit acoustic energy through the bottom of the wafer 316 to liquid that has been dispensed onto the top of the wafer 316. The transducer assembly 340 may include at least one acoustic wave transducer that operates at any desired frequency depending on design requirements. For example, the acoustic transducer may function at a megasonic frequency. The term “megasonic” refers to a range of frequencies, typically above approximately 400 kHz. However, other frequencies below approximately 400 kHz (e.g., ultrasonic frequencies) may also be used. A transducer controller 342 is connected to the transducer assembly 340 to provide any desired amount of power to the transducer assembly 340. The transducer controller 342 may also be connected to the process controller 208.

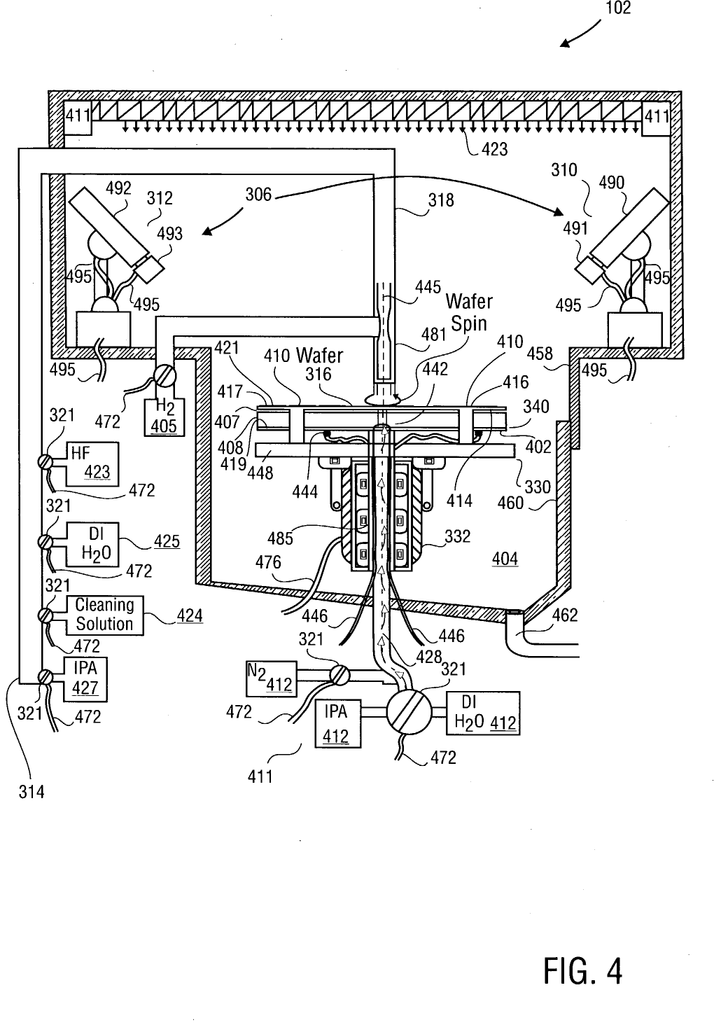

FIG. 4 illustrates a detailed side view of one embodiment of the single-wafer cleaning device 102 that may be utilized in conjunction with the in situ ellipsometer 306. The single-wafer cleaning device (“cleaning device”) may employ a variety of cleaning tools and techniques include wafer rotation, acoustic energy cavitation, and chemical action, all under temperature control. The cleaning device 102 includes a chamber 404 characterized by a chamber housing 460. Enclosed within the chamber 404 are the rotatable wafer holder 330, the transducer assembly 340, the motor 332, and the ellipsometer 306. Additionally, as shown, various parts of the fluid dispenser 314 may also be enclosed within the chamber 404.

According to one embodiment of the invention, the rotatable wafer holder 330 may comprise a rotatable wafer holding bracket 448 positioned over a circular platter 408. To initiate a wafer process cycle, the bracket 448 may translate along an axis 445 a distance upward and a robot arm (not shown) holding a wafer 316 may enter the interior of the chamber 404 through an access door 458 and place the wafer 316 in the bracket 448. The bracket 448 may then be lowered so as to align the wafer 316 horizontally a distance from the platter 408. The wafer 316, resting in the bracket 448, is parallel to the platter 408 and located a distance from the platter 408, thus forming a uniform gap 407 between the platter 408 and the wafer 316. The platter 408 is flat where it faces the wafer 316 thus the distance of the gap 407 separating the platter 408 and wafer 316 is uniform.

The platter 408 has a topside 417 and a bottom side 419. The platter topside 417 can be facing the wafer 316 as shown. In one embodiment of the invention, the platter 408 is fixed, but alternate embodiments can have the platter 408 able to translate along the bracket rotation axis 445 to open the gap 407 during wafer rinse or dry cycles. The wafer 316 is placed in the bracket 448 such that the wafer topside 416 is facing up and away from the platter 408. The wafer 316, when positioned in the bracket 448, rests on three or more vertical support posts 410 of the bracket 448. When placed in the bracket 448, the wafer 316 is centered over and held substantially parallel to the platter 408 to create the gap 407. Gravity and the downward flow of air 423 from a filter 411 maintain the wafer 316 positioned on the posts 410. Positioned beneath the platter 408 is an electric motor 422 for rotating the bracket 448. A wire extends from the motor 422 to a rotation controller as described in FIG. 3 above.

In one embodiment of the invention, the transducer assembly 340 may include at least one acoustic-wave transducer 402 (“transducer”) attached to the bottom side 419 of the platter 408. Within the chamber 404, the transducer 402 generates acoustic energy. The acoustic energy passes into the wafer 316 through fluids in contact with both the wafer 316 and the platter 408. Attached to the transducer 402 is a copper spring 444. The spring 444 could be of a variety of shapes to maintain electrical contact such as a wire coiled shape (shown) or a flexed foil constructed from sheet metal (not shown). Soldered to the spring's 444 free ends are wires 446. The platter 408 can be connected to the cleaning chamber housing 460 so as to act as ground for the electrical connections to the transducer 402 at springs 444. A through hole 485 exists in the electric motor 422 through which is passed the wiring 446 from the platter 408. The wiring 446 leads to a transducer controller as described in FIG. 3 above.

In one embodiment of the invention, the fluid dispenser 314, as described in FIG. 3 above, is included. However, according to the embodiment of the invention described in FIG. 4, an additional fluid dispenser 411 is required to dispense fluids to contact the bottom side of the wafer 316. To distinguish between the two fluid dispensers, the fluid dispenser 411 will be referred to as the first fluid dispenser 411 and the fluid dispenser 314 will be referred to as the second fluid dispenser 314. The first fluid dispenser 411 includes a tube 428 passing through the motor 422 that can transfer a first set of fluids 412 (“first fluids”) to a feed port 442. The feed port 442 can be located at the center of the platter 408 or the feed port 442 can be placed off-center by up to a few millimeters (not shown).

The second fluid dispenser 314, located above the platter 408 and the wafer 316, may include a nozzle 451 positioned near the end of the tube 318. Through the nozzle 451 can pass a second set of fluids 423, 424, 425, and 427 (“second fluids”) during processing. The nozzle 451 can direct a fluid flow 450 onto the wafer topside 416 with each of the fluids 423, 424, 425, and 427 in the cleaning process. The nozzle 451 can apply the fluids 423, 424, 425, and 427 to the wafer 316 while the wafer 316 is not moving or while the wafer 316 is spinning. The nozzle 451 can apply the fluids 423, 424, 425, and 427 at a flow rate to maintain a coating of the fluids 423, 424, 425, and 427 on the wafer topside 416 surface with minimal excess.

According to one embodiment of the invention, the nozzle 451 can apply a continuous chemical flow to maintain a film thickness on the wafer 316 of at least 100 microns. To keep the chemical film at the 100 microns thickness, the fluids 423, 424, 425, and 427 may be converted at the nozzle 451 into a mist having a particular mean diameter droplet size. All nozzle designs are limited as to how small a droplet size they can create. To meet the requirements of minimal fluid usage, a further reduction in droplet size may be required. One method of reducing the droplet size beyond a theoretical limit is to entrain, or dissolve, a gas, such as H₂ gas 405 or any other gas from the group of O₂, N₂, Ar, or He into the fluids 423, 424, 425, and 427. Valves 321 restrict the flow of the first and second fluids. In one embodiment, the valves 321 may be electronic and therefore may include wiring 472 attached to the valves 321 that may extend to corresponding fluid flow controllers as described in FIG. 3 above.

Referring still to FIG. 4, the bracket 448 and the wafer 316 are rotated while the first fluids 412 are applied from below to be in simultaneous contact with the platter 408 and the bottom side of the wafer 414. The second fluids 423, 424, 425, and 427 are wetted out onto the topside 416 of the wafer 316. The transducer 402 generates acoustic waves through the platter 408 into the first fluids 412, captured by the wafer 316 and the platter 408. The acoustic waves may be incident to the wafer bottom side 414 at an angle substantially normal (perpendicular) to the wafer surface 414. A percentage of the acoustic waves, depending on the frequency or frequencies used, can pass through the wafer 316 to exit the wafer top side 416 and enter the second fluids 423, 424, 425, and 427 that may be deposited as a film on the wafer top side 416. The acoustic waves acting within the second fluids 423, 424, 425, and 427 can produce cleaning on the wafer topside 416. For optimal throughput speed, the total area of the transducer 402 can be sufficient to provide approximately between 80-100% area coverage of the platter surface. The platter 408 diameter may be approximately the same size or larger than the wafer 316 diameter. The cleaning device 102 is scalable to operate on a wafer 316 that is 100 mm (diameter), 300 mm (diameter), or larger in size. If the wafer diameter is larger than the platter diameter, the vibrations from the acoustic energy striking the wafer 316 can still travel to the wafer 316 outer diameter providing full coverage for the cleaning action.

During the cleaning process the wafer 316 may be rotated at a selected revolution per minute (rpm) about the axis 445. Additionally, to optimize any particular cycle, the wafer spin rate may be stopped or varied and the sonic energy varied by changing any combination of the power setting, the frequency or frequencies, and by pulsing. Therefore, when the bracket 448 is in operation, the wafer 316 may be exposed to the first fluids 412 on the bottom side 414, and the second fluids 423, 424, 425, 427 on the topside 416, while the wafer 316 is being rotated and radiated with acoustic energy.

Acoustic waves can first strike the wafer bottom side 414 where no structures 421 exist that could be damaged by the full force of the acoustic energy. Depending on the frequency or frequencies used, the acoustic energy may be dampened to a degree when passing through the platter 408 and wafer 316 to exit into the cleaning or rinse fluids 423, 424, 425, and 427 at the wafer top side 416. As a result, the acoustic energy striking the wafer bottom side 414 may be powerful enough that only de-ionized (DI) water is used as the first fluids 412.

A drain 462 may be provided within the cleaning chamber housing 460 to collect the cleaning fluids. A cleaning chamber floor 463 may be angled toward the drain 462 to improve flow of the fluids 412, 423, 424, 425, and 427 to the drain 462.

Still referring to FIG. 4, the cleaning device 102 includes an in situ ellipsometer 306 having a transmitter 310 with a laser 490 (e.g., a 632.8 nm helium/neon laser) to generate a laser light beam (“light beam”) and a polarizer 491 to provide polarization of a light beam. The angle of the polarizer 491 can be varied to provide linearly polarized light, elliptically polarized light, or circularly polarized light. The in situ ellipsometer 306 may further include a receiver 312 with a detector 492 and an analyzer 493. The analyzer 493 angle can also be varied to measure polarization of a reflected light beam and the detector 492 can measure signal intensity. The ellipsometer 306 may also include wiring 495 that leads to a process controller as described in FIG. 3 above.

Methods

FIGS. 5A-5F illustrate a method of monitoring and controlling a wet etch within a cleaning process according to one embodiment of the invention. The method may begin, as shown in FIG. 5A, with placing a wafer 316 on a rotatable wafer holder 330 inside the single-wafer cleaning device 102. Other devices including the ellipsometer transmitter 310 and receiver 312, and the process controller 208 are shown in context.

The method continues, as shown in FIG. 5B, with measuring optical path lengths of a light beam (i.e., making optical measurements) that relate to a thickness of the thin film layer 510 on the wafer 316. The optical measurements of the thin film layer 510 are made according to conventional ellipsometry. For conventional ellipsometry to work, however, the thin film layer 510 should be a semi-transparent material that is capable of being measured via a light beam. For example, the thin film layer 510 may be a pad oxide layer, a nitride mask layer, an STI liner oxide layer, an implant screen oxide layer, or a sacrificial oxide layer. The thin film layer may also comprise any one of many materials including silicon oxide, silicon nitride, or other thin semi-transparent materials known in the art. Ellipsometer measurement techniques are well known in the art and need no detailed description herein. However, in short, a laser light beam 512 is generated and polarized by the transmitter 310 and passed through the thin film layer 510. Since the thin film layer 510 is semi-transparent, the polarized light beam 512 passes through the thin film layer 510 and reflects off of the underlying, non-transparent wafer 316. The reflection 514 is detected and analyzed by the receiver 312 according to a complex process well known in the art, that compares various factors, such as (1) the original polarization and magnitude of the light beam 512 before the light beam 512 passes through the thin film layer 510, (2) the polarization and magnitude of the reflected light beam 514, and (3) the index of refraction of the thin film layer 510, if known. After the distance of the optical path lengths of the light beams 512 and 514 are measured, the thicknesses of the thin film layer 510 can then be determined by calibrating the ellipsometer to the material. At certain places herein, the measurements made by the ellipsometer are referred to as optical measurements. In other places, the measurements made by the ellipsometer are referred to as “thickness measurements”, even though technically, the measurements are of the optical path lengths of the light beams 512 and 514, and the “actual” thicknesses of the materials that the light beam passes through is determined only after calibrating the device to the actual material that is being processed. Hence, the thickness of the thin film layer 510 may be referred to herein as a “beginning thickness” of the thin film layer 510, or Thₜₗ_{_{—}}_{^{begin}}, but may simply means the distance of the light beam as measured by the ellipsometer that relates to the actual beginning thickness of the thin film layer 510. Once the machine is calibrated, then the term “thickness” may refer to actual material thicknesses of the thin film.

The method may continue, as shown in FIG. 5C, with beginning a first phase of a cleaning etch by dispensing a liquid layer 520 over the thin film layer 510 at a constant flow rate to maintain a uniform liquid layer 520 thickness. Liquid layer 520 may comprise the second fluids 423, 424, 425, and 427 described in FIG. 4 above. Additionally, liquid layer 520 may include any liquid used in an RCA (Radio Corporation of America) cleaning process including deionized water (DI), ammonia peroxide solution (NH₄OH:H₁₀₂) or SC-1, hydrofluoric acid solution (HF), and hydrochloric peroxide solution (HCl:H₂O₂), or SC-2. Liquid layer 520 may also include any chemical or solution capable of etching a thin film layer. For example, phosphoric acid (H₃PO₄) is known to etch nitrides, while hydrofluoric acid is known to etch oxides. Various other chemicals and solutions associated with conventional wet etching and cleaning processes include, but are not limited to, hydrochloric acid, ammonia peroxide, hydrochloric peroxide, sulpheric peroxide, sulpheric peroxide fluoride, sulfuric ozone, hydroflorine, isopropyl alcohol, n-methyl pyrrolidone, and potassium hydroxide.

Next, as shown in FIG. 5D, the method may additionally include making a plurality of ellipsometer optical path length measurements, in real time, relating to the composite thickness of the liquid layer 520 plus the thin film layer 510 at various times during the wet cleaning process, then determining a difference in the optical path lengths, which corresponds to a thickness difference between the plurality of composite thickness measurements. More specifically, the polarized light beam 512 is passed through both the liquid layer 520 and the thin film layer 510 and reflects off of the substrate 316. The reflection 514 is detected and analyzed after the reflection exits the liquid layer 520. A first composite thickness (Th_{comp1}) of the liquid layer 520 plus the thin film layer 510 is measured at a first moment in time, herein referred to as the beginning time (t1), of the wet cleaning etch. At any time before or after the liquid layer 520 is dispensed, the method may also include performing mechanical cleaning techniques, such as rotating the wafer and/or cavitating the liquid layer via acoustic waves. According to one embodiment of the invention, megasonic energy is applied to the rotating wafer 316 during the cleaning process, as described in conjunction with FIG. 3 and FIG. 4 above. The megasonic energy may be in a frequency range of 400 kHz-8 Mz but may be higher. Megasonic energy may be transmitted through the wafer 316 and into the liquid layer 520, or megasonic energy may be transmitted to the liquid that comprises the liquid layer 520 as the liquid is being dispensed onto the thin film layer 510. Wafer rotation and acoustic cavitation may cause the liquid layer 520 to be slightly turbulent. Therefore, according to one embodiment of the invention, phase modulation technology may be utilized to essentially filter out minor fluctuations in the liquid surface during ellipsometry measurements. Phase modulation techniques are known in the art and need no detailed explanation herein.

Next, as shown in FIG. 5E, after the wet etch continues for a given amount of time, a second composite thickness (Th_{comp2}) can be measured at a second moment in time. Herein, the second moment in time may be referred to as an intermediate time (t2) to distinguish it from the beginning time (t1). During the process, the liquid layer 520 should be kept uniform so that any difference in thicknesses between the first composite thickness and the second composite thickness represent only a difference in the underlying thin film layer 510.

The method continues, as shown in FIG. 5F, with transmitting the thickness measurements (i.e., optical path length measurements) of the two composite measurements Th_{comp1} and Th_{comp2} and the beginning measurement Thₜₗ_{_{—}}_{^{begin}}, to the process controller 208. The beginning measurement Thₜₗ_{_{—}}_{^{begin}} and the first composite thickness measurement Th_{comp1} may be transmitted as they occur in time and may be stored in memory until the second composite measurement Th_{comp2} is made and transmitted. The measurement signals may be converted into machine-readable language by the process controller 208.

Once all measurements are received and converted by the process controller 208, an etch rate may then be determined. The etch rate may be determined by (1) determining a composite thickness difference (ThΔ_{comp}) by subtracting Th_{comp2} from Th_{comp1} (i.e., ThΔ_{comp=}Th_{comp1-}Th_{comp2}); (2) determining an elapsed time difference (tΔ) between measurements of the composite thickness by subtracting t1 from t2 (i.e., tΔ₌t2−t1); and (3) dividing the composite thickness (ThΔ_{comp}) by the time difference (tΔ), (i.e., etch rate=ThΔ_{comp/}tΔ.)

Once the etch rate is determined, an endpoint for the wet etch may be determined based on the etch rate. The endpoint may be determined by (1) determining a thin film layer thickness difference (ThΔₜₗ) by subtracting a predetermined end thickness (Thₜₗ_{_{—}}_{^{end}}) of the thin film layer 510 from the beginning thickness (Thₜₗ_{_{—}}_{^{begin}}) of the thin film layer 510 (i.e., ThΔₜₗ=Thₜₗ_{_{—}}_{^{begin}}−Thₜₗ_{_{—}}_{^{pre}}_{_{—}}_{^{end}}); and (2) dividing the thin film layer thickness difference by the etch rate, (i.e., endpoint=ThΔₜₗ/etch rate.) The predetermined end thickness (Thₜₗ_{_{—}}_{^{end}}) mentioned above represents the desired thickness of the thin film layer which, when reached, will be the end of an etching phase. The predetermined end thickness may be stored in memory within the process controller 208, and the etching process may include more than one end thickness depending on different phases of the wet etch. If the thin film layer is to be wet etched entirely in a single phase, then the predetermined end thickness would be equal to zero, and the endpoint would simply be computed by dividing the beginning thin film layer thickness by the etch rate.

Once the endpoint is determined, the endpoint can be utilized to control timing of the wet cleaning etch. For example, if the wet etch is divided into different phases, the endpoint will represent a point in time that a phase of the cleaning etch will end, (e.g., the end of the first etching phase). During the first phase, the liquid layer 520 may comprise a etch chemical to etch the thin film layer 510 to a certain thickness. Once etched, a second phase may need to be performed, such as performing a rinse. If an endpoint for the first phase can be predicted, according to the method, then the in-situ rate monitor, or more specifically the process controller 208, may have knowledge of the system conditions and may recognize that the second phase may require “switching” actions whereby certain devices may need to be activated, deactivated, or in some other way controlled. For example, a rinse may require that DI water be dispensed. However, before the DI water can be dispensed, valves may need to be opened and closed, temperature and pressure measurements may need to be made, devices may need to be powered up or powered down, etc. These “switching” actions may require time to perform, of which the process controller 208 is aware. Thus, if an endpoint is predicted for the first phase, the process controller 208 can produce control signals that will begin the switching actions for the second phase before the first phase finishes, thus causing the entire process to flow more efficiently.

Consequently, controlling the wet cleaning etch includes creating control signals based on the predicted endpoints and transmitting the control signals to electronic devices in the cleaning device 102. If more than one control signal must be delivered to devices according to a certain sequence, the process controller 208 may use the endpoints to create a series of control values that are stored in memory that represent when certain control signals will need to be sent to the cleaning device 102. The control values may be organized according to a timing schedule that follows the sequence. As time progresses, the control values may be sequentially converted into control signals according to the timing schedule, and the control signals can be transmitted, in turn, to corresponding devices on the cleaning device 102.

Furthermore, it should be further emphasized that the “actual” thicknesses of the thin film and the liquid layer do not need to be determined during the process because “relative” measurement signals may be produced through optical measuring. More specifically, when the method describes making a first thickness measurement, the first thickness measurement is really of the first optical path length created by the ellipsometer. A final optical path length, or the length that light beam will be when the endpoint is reached, can be estimated utilizing the first optical path length, the index of refraction of the thin film, the angle of polarization, and other variables. Subsequent measurements of optical path lengths made during the wet cleaning etch, therefore, may be made and compared to the estimated final path length.

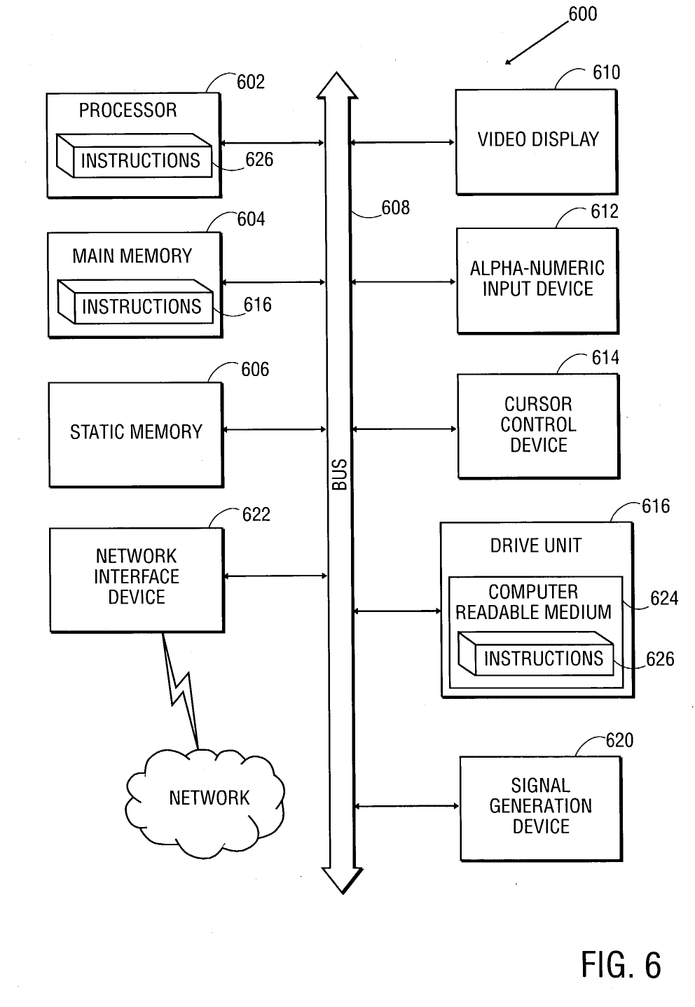

FIG. 6 is a representation of a computer system 600 that may be utilized in conjunction with embodiments of the invention described herein. For example, computer system 600 may represent an example of the computers 212 or 350 described in conjunction with FIGS. 2 and 3 above. The computer system 600 may include a processor 602, a main memory 604 and a static memory 606, which communicate with each other via a bus 608. The computer system 600 may further include a video display unit 610 (e.g., a liquid crystal display (LCD) or a cathode ray tube (CRT)). The computer system 600 also may include an alphanumeric input device 612 (e.g., a keyboard), a cursor control device 614 (e.g., a mouse), a disk drive unit 616, a signal generation device 620 (e.g., a speaker) and a network interface device 622. The disk drive unit 616 includes a computer-readable medium 624 on which is stored a set of instructions (i.e., software) 626 embodying any one, or all, of the methodologies described above. The software 626 is also shown to reside, completely or at least partially, within the main memory 604 and/or within the processor 602. The software 626 may further be transmitted or received via the network interface device 622. For the purposes of this specification, the term “computer-readable medium” shall be taken to include any medium that is capable of storing or encoding a sequence of instructions for execution by the computer and that cause the computer to perform any one of the methodologies of the present invention. The term “computer-readable medium” shall accordingly be taken to include, but not be limited to, solid-state memories, optical and magnetic disks, and carrier wave signals.

Some portions of the detailed descriptions herein are presented in terms of algorithms and/or symbolic representations of operations on data bits within a computer memory. Unless specifically stated otherwise as apparent from the previous discussion, terms such as “computing” or “calculating” or “determining” or the like, may refer to the action and processes of the computer system 600 as described above, or a similar electronic computing device, that manipulates and transforms data represented as physical (electronic) quantities within the computer system's registers and memories into other data similarly represented as physical quantities within the computer memories or registers or other such information storage, transmission or display devices. However, such algorithmic and symbolic representations of operations are not inherently related to any particular computer or other apparatus. Various general-purpose systems may be used with programs in accordance with the teachings herein, or it may prove convenient to construct more specialized apparatus to perform the required methodology.

Several embodiments of the invention have thus been described. However, those ordinarily skilled in the art will recognize that the invention is not limited to the embodiments described, but can be practiced with modification and alteration within the spirit and scope of the appended claims that follow.

What is claimed:

1. An apparatus, comprising:
a single-wafer cleaning device to provide a wet cleaning process to a wafer; and
a rate monitor connected to the single-wafer cleaning device to measure and control the wet cleaning process.

2. The apparatus of claim 1, wherein the rate monitor is to measure a rate at which a wet cleaning etch is progressing, predict an endpoint in time of the wet cleaning etch, and provide control signals that may be utilized to control the single-wafer cleaning device before the endpoint has been reached.

3. The apparatus of claim 1, wherein the rate monitor comprises:
an optical measuring device inside of the single-wafer cleaning device to make optical measurements that relate to a thickness of a thin film of a thin film layer overlying the wafer; and
a process controller connected to the optical measuring device, the process controller to determine an etch-rate of the thin film during a wet cleaning etch based on the optical measurement, to predict an endpoint to the wet cleaning etch based on the etch-rate, and to provide control signals to the single-wafer cleaning device based on the predicted endpoint.

4. The apparatus of claim 3, wherein the optical measuring device is an ellipsometer.

5. The apparatus of claim 3, wherein the optical measuring device comprises:
a transmitter to transmit a polarized light beam through the thin film layer and through a liquid layer overlying the thin film layer; and
a receiver to receive and analyze a reflection of the polarized light beam as the wafer is being cleansed to generate an optical measurement signal corresponding to the thickness of the thin film layer and the liquid layer.

6. The apparatus of claim 5, wherein the process controller is to receive the optical measurement signal and calculate the etch-rate based on the optical measurement signal.

7. The apparatus of claim 3, wherein the process controller is connected to the single-wafer cleaning device and is to provide control signals to the single-wafer cleaning device based on the predicted endpoint.

8. The apparatus of claim 1, wherein the single-wafer cleaning device comprises:
a fluid dispenser to dispense a liquid onto the wafer including a fluid flow controller to control the flow of the liquid;
a rotatable wafer holder to hold and rotate the wafer including a rotation controller to control rotation of the holder; and
a transducer assembly to provide acoustic energy to the liquid including a transducer controller to control power to the transducer assembly.

9. The apparatus of claim 8, wherein the rate monitor is connected to the fluid flow controller, the rotation controller, and the transducer controller, and said rate monitor is to provide control signals to the fluid flow controller, rotation controller, and transducer controller to control the wet cleaning process.

10. An apparatus, comprising:
a rotatable wafer holder to hold and rotate a wafer;
a fluid dispenser to dispense a liquid onto a thin film layer on the wafer;
a transducer assembly to provide acoustic energy to the liquid; and
a rate monitor to measure the thickness of the thin film layer during a wet cleaning etch, to predict an endpoint of the wet cleaning etch, and to control the rotatable wafer holder, fluid dispenser, and transducer assembly based on the predicted endpoint.

11. The apparatus of claim 10, wherein the rate monitor comprises an ellipsometer.

12. The apparatus of claim 10, wherein the rate monitor comprises:
a transmitter to transmit a polarized light beam onto the wafer; and
a receiver to receive and analyze a reflection of the polarized light beam.

13. The apparatus of claim 10, further comprising a cleaning chamber to contain at least a portion of the rotatable wafer holder, fluid dispenser, transducer assembly, and rate monitor.

14. The apparatus of claim 10, wherein the rotatable wafer holder has a variable rotation speed.

15. The apparatus of claim 10, wherein the fluid dispenser includes a plurality of cleaning fluid sources.

16. The apparatus of claim 10, wherein the transducer assembly is capable of producing acoustic energy at a plurality of megasonic frequencies.

17. An apparatus, comprising:
an ellipsometer coupled to a single-wafer cleaning device to make optical measurements relating to a thickness of a thin film layer overlying a wafer; and
a process controller connected to the ellipsometer, the process controller to control a wet cleaning process based on the optical measurements.

18. The apparatus of claim 17, wherein the ellipsometer is inside the single-wafer cleaning device.

19. The apparatus of claim 17, wherein the ellipsometer includes
a transmitter to transmit a polarized light beam onto a wafer; and
a receiver to receive and analyze a reflection of the polarized light beam, the transmitter and receiver inside a single-wafer cleaning device.

20. The apparatus of claim 17, wherein the process controller is to receive a measurement signal from the ellipsometer, to determine an etch rate for the wet cleaning etch based on the measurement signal, and to predict an endpoint to the etch based on the determined etch rate.

21. The apparatus of claim 20, wherein the process controller is to control the wet cleaning etch based on the predicted endpoint.

22. An apparatus, comprising:
a semiconductor substrate,
a thin film layer overlying the substrate,
a liquid layer overlying the thin film layer; and
an ellipsometer coupled to a single-wafer cleaning device, the ellipsometer to measure the thickness of the thin film layer and the liquid layer.

23. The apparatus of claim 22, wherein the thin film layer comprises a semi-transparent material.

24. The apparatus of claim 22, wherein the semiconductor substrate comprises a non-transparent material.

25. The apparatus of claim 22, wherein the liquid layer comprises a chemical capable of etching the thin film layer.

26. The apparatus of claim 22, wherein the semiconductor substrate, the thin film layer, the liquid layer, and the ellipsometer are inside a single-wafer cleaning device.

27. A method, comprising:
performing a wet cleaning process to a thin film layer on a wafer; and
monitoring changes to the thin film as the wet cleaning process is being performed to predict an endpoint for the wet cleaning process.

28. The method of claim 27 wherein monitoring the thin film comprises:
monitoring the rate at which changes are occurring to the thin film;
predicting an endpoint reference in time, based on the rate, of when the wet cleaning process will end; and
controlling the wet cleaning process after the endpoint has been predicted and before the endpoint has been reached, in preparation for additional processing that may occur after the endpoint has been reached.

29. The method of claim 27, wherein monitoring is performed in situ during the wet cleaning process with a liquid layer covering the thin film.

30. The method of claim 27, further comprising:
rotating the wafer; and
optically monitoring the changes to the thin film layer during the wet cleaning process as the wafer rotates.

31. The method of claim 27, further comprising:
cavitating a liquid layer overlying the thin film layer; and
optically monitoring the changes to the thin film layer during the wet cleaning process as the liquid layer cavitates.

32. The method of claim 27, further comprising controlling the wet cleaning process based on the predicted endpoint.

33. The method of claim 27, wherein performing a wet cleaning process includes:
dispensing a liquid onto the thin film layer to form a liquid layer over the thin film layer;
rotating the wafer; and
cavitating the liquid layer.

34. The method of claim 27, further comprising:
making optical measurements relating to a thickness of the thin film layer during the wet cleaning process;
determining an etch rate of the thin film layer;
determining an endpoint for the wet cleaning etch based on the etch rate; and
controlling the wet cleaning etch based on the predicted endpoint.

35. The method of claim 27, wherein the thin film is semi-transparent to a light beam and the wafer is non-transparent, and wherein monitoring changes to the thin film comprises:
passing a light beam through the thin film layer to produce a reflection of the light beam off of the wafer, the light beam and reflection having an optical path length;
making a first measurement of the optical path length;
dispensing a liquid layer over the thin film layer at a constant flow rate to maintain a uniform liquid layer thickness;
making a second measurement of the optical path length at a first moment before beginning a wet cleaning etch of the thin layer;
beginning a wet cleaning etch of the thin layer;
making a third optical measurement of the optical path length at a second moment after etching has begun;
determining an optical measurement difference between the first optical measurement and the second optical measurement;
determining an elapsed time difference between the beginning of the wet cleaning etch and the third optical measurement by determining the elapsed time between the first moment and the second moment;
determining an etch rate based on the optical measurement difference and the elapsed time difference; and
determining an endpoint to the wet etch based on the etch rate and the first optical measurement.

36. A method, comprising:
measuring a thickness of a thin film layer on a wafer during a wet cleaning etch;
determining an etch rate of the thin film layer; and
determining an endpoint for the wet cleaning etch based on the etch rate.

37. The method of claim 36, wherein measuring a thickness of a thin film layer comprises:
measuring a beginning thickness of the thin film layer;
dispensing a liquid layer over the thin film layer at a constant flow rate to maintain a uniform liquid layer thickness, the liquid layer and thin film layer having a composite thickness;
measuring a first composite thickness of the liquid layer and thin film layer at a first time during the wet cleaning etch; and
measuring a second composite thickness of the liquid layer and thin film layer at a second time during the wet cleaning etch.

38. The method of claim 37, wherein determining an etch rate of the thin film layer comprises:
determining a composite thickness difference between the first composite thickness and the second composite thickness;
determining an elapsed time difference between the first time and the second time; and
computing an etch rate by dividing the composite thickness difference by the elapsed time difference.

39. The method of claim 38, wherein determining an endpoint comprises dividing the beginning thickness by the etch rate.

40. The method of claim 36, further comprising:
controlling the wet cleaning etch based on the endpoint.

41. The method of claim 40, wherein controlling the wet cleaning etch comprises:
creating control signals based on the endpoints; and
transmitting the control signals to a single-wafer cleaning device.

42. The method of claim 40, wherein controlling the wet cleaning etch comprises:
creating a series of control values based on the endpoints;
organizing and storing the control values in memory according to a timing schedule; and
sequentially converting the control values to control signals according to the timing schedule and transmitting the control signals to a single-wafer cleaning device.

43. A computer readable storage medium containing executable computer program instructions which, when executed, cause a digital processing system to perform a method comprising:
determining an etch rate of the thin film layer on a wafer during a wet cleaning etch; and
determining an endpoint for the wet cleaning etch based on the etch rate.

44. The computer readable storage medium of claim 43, wherein the method comprises:
determining a composite thickness difference between a first composite thickness of a thin film and a liquid layer and a second composite thickness of the thin film and the liquid layer after the liquid layer has etched the thin film over an elapsed time; and
determining the etch rate of the thin film by dividing the composite thickness difference by the elapsed time.

45. The computer readable storage medium of claim 44, wherein the method comprises:
creating control signals based on the endpoints; and
transmitting the control signals to a single-wafer cleaning device.

46. The computer readable storage medium of claim 45, wherein the method comprises:
creating a series of control values based on the endpoints;
organizing and storing the control values in memory according to a timing schedule; and
sequentially converting the control values to control signals according to the timing schedule and transmitting the control signals to a single-wafer cleaning device.
